(19) United States
(12) Patent Application Publication
(10) Pub. No.: US 2022/0029537 A1
(43) Pub. Date: Jan. 27, 2022

(54) OPTIMIZING TRANSITIONS BETWEEN OPERATIONAL MODES IN A BYPASSABLE POWER CONVERTER

(71) Applicant: Cirrus Logic International Semiconductor Ltd., Edinburgh (GB)

(72) Inventors: Jason W. LAWRENCE, Austin, TX (US); Graeme G. MACKAY, Austin, TX (US); Theodore M. BURK, Cedar Park, TX (US); Sakkarapani BALAGOPAL, Austin, TX (US)

(73) Assignee: Cirrus Logic International Semiconductor Ltd., Edinburgh (GB)

(21) Appl. No.: 17/149,338

(22) Filed: Jan. 14, 2021

Related U.S. Application Data
(60) Provisional application No. 63/055,958, filed on Jul. 24, 2020.

(51) Int. Cl. H02M 3/158

(52) U.S. Cl. CPC H02M 3/1582

(57) ABSTRACT

In accordance with embodiments of the present disclosure, a power conversion system may include a power converter configured to receive an input voltage and generate an output voltage, a bypass switch arranged in parallel with the power converter and arranged to couple the input voltage to the output voltage when the bypass switch is activated, and a control circuit configured to control the power converter and the bypass switch based on the output voltage.

### RELATED APPLICATION

The present disclosure claims priority to U.S. Provisional Patent Application Ser. No. 63/055,958 filed Jul. 24, 2020, which is incorporated by reference herein in its entirety.

### FIELD OF DISCLOSURE

The present disclosure relates in general to circuits for electronic devices, including without limitation personal audio devices such as wireless telephones and media players, and more specifically, to prediction of a load current and a control current in a power converter using output voltage thresholds.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones or one or more speakers. Such circuitry often includes a speaker driver including a power amplifier for driving an audio output signal to headphones or speakers. Oftentimes, a power converter may be used to provide a supply voltage to a power amplifier in order to amplify a signal driven to speakers, headphones, or other transducers. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier.

A power converter may be used to provide supply voltage rails to one or more components in a device. Accordingly, it may be desirable to regulate an output voltage of a power converter with minimal ripple in the presence of a time-varying current and power load.

### SUMMARY

In accordance with the teachings of the present disclosure, one or more disadvantages and problems associated with existing approaches to regulating an output voltage of a power converter may be reduced or eliminated.

In accordance with embodiments of the present disclosure, a power conversion system may include a power converter configured to receive an input voltage and generate an output voltage, a bypass switch arranged in parallel with the power converter and arranged to couple the input voltage to the output voltage when the bypass switch is activated, and a control circuit configured to control the power converter and the bypass switch based on the output voltage.

In accordance with these and other embodiments of the present disclosure, a method may be provided for use in a power conversion system, comprising a power converter configured to receive an input voltage and generate an output voltage and a bypass switch arranged in parallel with the power converter and arranged to couple the input voltage to the output voltage when the bypass switch is activated. The method may include controlling the power converter and the bypass switch based on the output voltage.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example mobile device, in accordance with embodiments of the present disclosure;

FIG. 2 illustrates a block diagram of selected components internal to a mobile device, in accordance with embodiments of the present disclosure;

FIG. 3A illustrates a block diagram of selected components of an example boost converter with multiple modes of operation depicting operation in a bypass mode, in accordance with embodiments of the present disclosure;

FIG. 3B illustrates a block diagram of selected components of an example boost converter with multiple modes of operation depicting operation in a boost active mode, in accordance with embodiments of the present disclosure;

FIG. 3C illustrates a block diagram of selected components of an example boost converter with multiple modes of operation depicting operation in a boost inactive mode, in accordance with embodiments of the present disclosure;

FIG. 4 illustrates a block diagram of selected components of an example control circuit for a boost converter, in accordance with embodiments of the present disclosure;

FIG. 5 illustrates a block diagram of a state machine that may be implemented by a timer, in accordance with embodiments of the present disclosure;

FIG. 6 illustrates an example timing diagram associated with the state machine implemented by a timer, in accordance with embodiments of the present disclosure;

FIG. 7 illustrates an example timing diagram of various signals associated with the control circuit of FIG. 4, in accordance with embodiments of the present disclosure;

FIG. 8 illustrates a block diagram of selected components of an example control circuit for another boost converter, in accordance with embodiments of the present disclosure;

FIG. 9 illustrates a block diagram of a state machine that may be implemented by a timer, in accordance with embodiments of the present disclosure;

FIG. 10 illustrates an example timing diagram associated with the state machine implemented by a timer, in accordance with embodiments of the present disclosure; and

FIG. 11 illustrates an example timing diagram of various signals associated with the control circuit of FIG. 8, in accordance with embodiments of the present disclosure.

### DETAILED DESCRIPTION

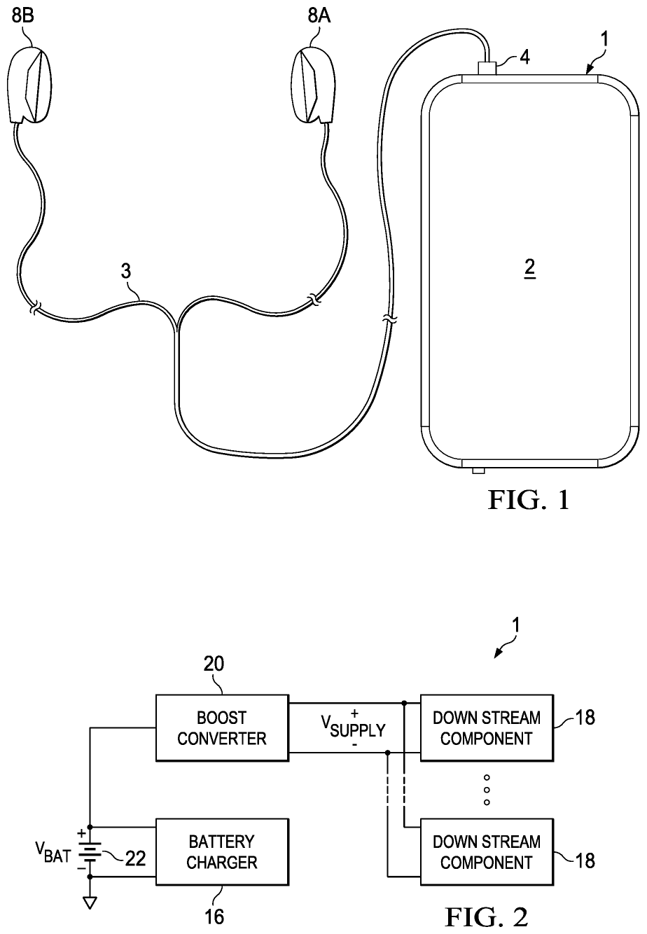

FIG. 1 illustrates an example mobile device 1, in accordance with embodiments of the present disclosure. FIG. 1 depicts mobile device 1 coupled to a headset 3 in the form of a pair of earbud speakers 8A and 8B. Headset 3 depicted in FIG. 1 is merely an example, and it is understood that mobile device 1 may be used in connection with a variety of audio transducers, including without limitation, headphones, earbuds, in-ear earphones, and external speakers. A plug 4 may provide for connection of headset 3 to an electrical terminal of mobile device 1. Mobile device 1 may provide a display to a user and receive user input using a touch screen 2, or alternatively, a standard liquid crystal display (LCD) may be combined with various buttons, sliders, and/or dials disposed on the face and/or sides of mobile device 1.

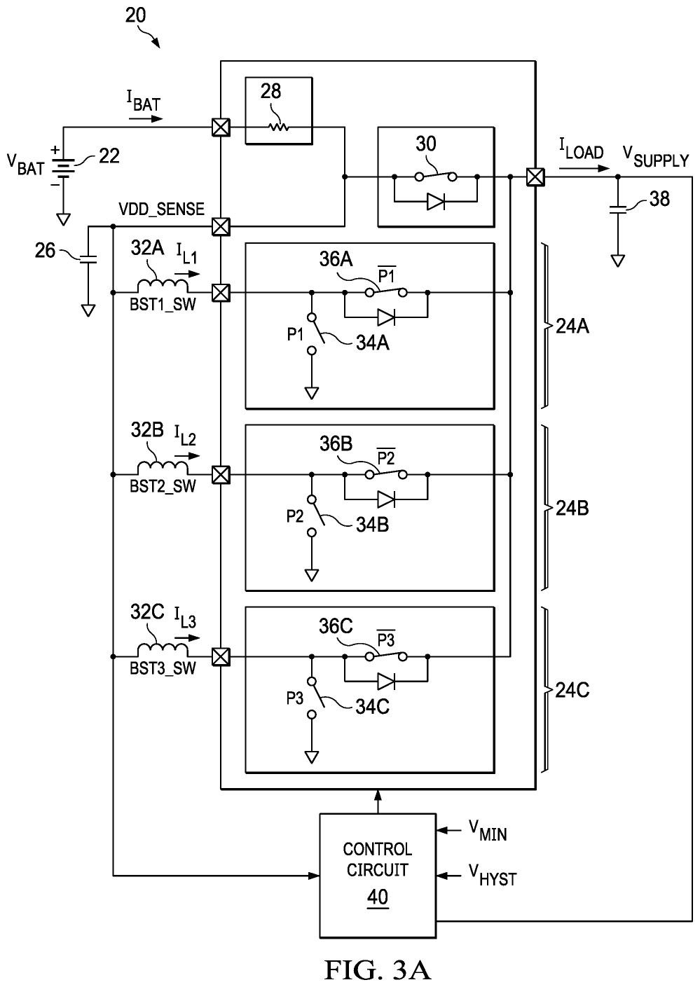

FIG. 2 illustrates a block diagram of selected components integral to mobile device 1, in accordance with embodiments of the present disclosure. As shown in FIG. 2, mobile device 1 may include a boost converter 20 configured to boost a battery voltage V_{BAT} to generate a supply voltage V_{SUPPLY} to a plurality of downstream components 18 of mobile device 1. Downstream components 18 of mobile device 1 may include any suitable functional circuits or devices of mobile device 1, including without limitation processors, audio coder/decoders, amplifiers, display devices, etc. As shown in FIG. 2, mobile device 1 may also include a battery charger 16 for recharging battery 22.

In some embodiments of mobile device 1, boost converter 20 and battery charger 16 may comprise the only components of mobile device 1 electrically coupled to battery 22, and boost converter 20 may electrically interface between battery 22 and all downstream components of mobile device 1. However, in other embodiments of mobile device 1, some downstream components 18 may electrically couple directly to battery 22.

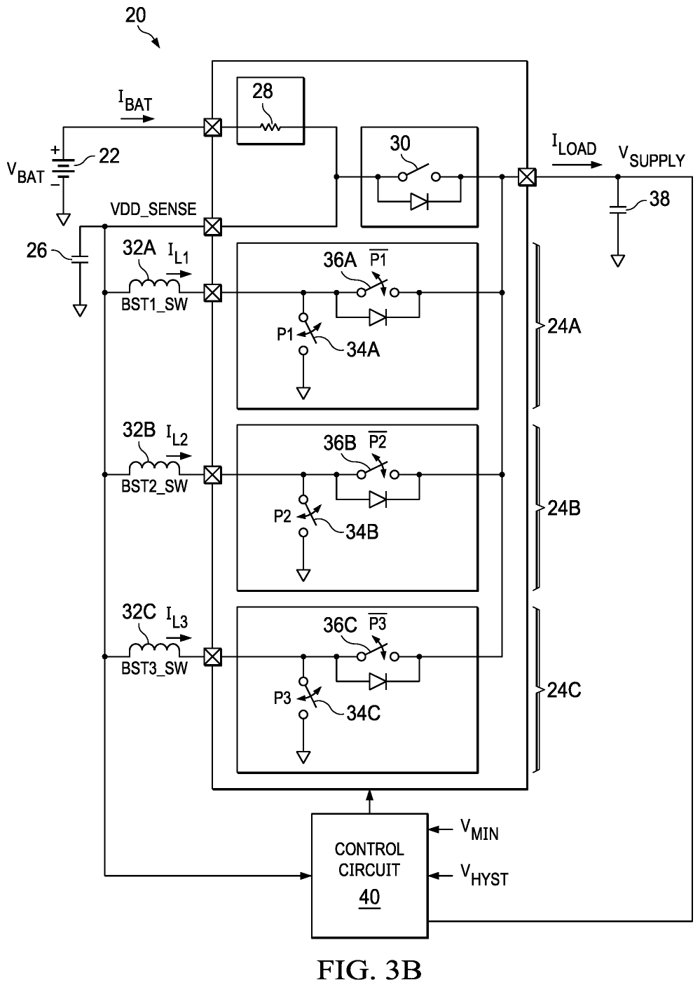

FIG. 3A illustrates a block diagram of selected components of an example boost converter 20 with multiple modes of operation depicting operation in a bypass mode, in accordance with embodiments of the present disclosure. As shown in FIG. 3A, boost converter 20 may include a battery 22, a plurality of inductive boost phases 24, a sense capacitor 26, a sense resistor 28, a bypass switch 30, and a control circuit 40. As shown in FIG. 3A, each inductive boost phase 24 may include a power inductor 32, a charge switch 34, a rectification switch 36, and output capacitor 38.

Although FIGS. 3A-3C depict boost converter 20 having three inductive boost phases 24, embodiments of boost converter 20 may have any suitable number of inductive boost phases 24. In some embodiments, boost converter 20 may comprise three or more inductive boost phases 24. In other embodiments, boost converter 20 may comprise fewer than three phases (e.g., a single phase or two phases).

Boost converter 20 may operate in the bypass mode when supply voltage V_{SUPPLY} generated by boost converter 20 is greater than a threshold minimum voltage V_{MIN} and a voltage VDD_SENSE across sense capacitor 26 is greater than supply voltage V_{SUPPLY}. In some embodiments, such threshold minimum voltage V_{MIN} may be a function of a monitored current (e.g., a current through sense resistor 28). In some embodiments, such threshold minimum voltage V_{MIN} may be varied in accordance with variations in the monitored current, in order to provide desired headroom from components supplied from supply voltage V_{SUPPLY}. Thus, control circuit 40 may be configured to sense supply voltage V_{SUPPLY} and compare supply voltage V_{SUPPLY} to threshold minimum voltage V_{MIN}, as well as sense voltage VDD_SENSE and compare supply voltage V_{SUPPLY} to voltage VDD_SENSE. In the event that supply voltage V_{SUPPLY} is greater than threshold minimum voltage V_{MIN} and VDD_SENSE across sense capacitor 26 is greater than supply voltage V_{SUPPLY}, control circuit 40 may activate (e.g., enable, close, turn on) bypass switch 30 and one or more rectification switches 36 and deactivate (e.g., disable, open, turn off) charge switches 34. In such bypass mode, the resistances of rectification switches 36, power inductors 32, and bypass switch 30 may combine to minimize a total effective resistance of a path between battery 22 and supply voltage V_{SUPPLY}.

FIG. 3B illustrates a block diagram of selected components of example boost converter 20 depicting operation in a boost active mode, in accordance with embodiments of the present disclosure. In the boost active mode, control circuit 40 may deactivate (e.g., disable, open, turn off) bypass switch 30, and periodically commutate charge switches 34 (e.g., during a charging state of an inductive boost phase 24) and rectification switches 36 (e.g., during a transfer state of an inductive boost phase 24) of inductive boost phase 24 (as described in greater detail below) by generating appropriate control signals P₁, P₁⁻, P₂, P₂⁻, , P₃, and P₃⁻, to deliver a current I_{BAT} and boost battery voltage V_{BAT} to a higher supply voltage V_{SUPPLY} in order to provide a programmed (or servoed) desired current (e.g., average current) to the electrical node of supply voltage V_{SUPPLY}, while maintaining supply voltage V_{SUPPLY} above threshold minimum voltage V_{MIN}. For example, control circuit 40 may operate in the boost active mode to maintain an inductor current I_{L} (e.g., I_{L1}, I_{L2}, I_{L3}) between a peak current and a valley current as described in U.S. patent application Ser. No. 17/119,517 filed Dec. 11, 2020, and incorporated by reference herein in its entirety. In the boost active mode, control circuit 40 may operate boost converter 20 by operating inductive boost phase 24 in a peak and valley detect operation, as described in greater detail below. The resulting switching frequency of charge switches 34 and rectification switches 36 of inductive boost phase 24 may be determined by the sense voltage VDD_SENSE, supply voltage V_{SUPPLY}, an inductance of power inductor 32A, and a programmed ripple parameter (e.g., a configuration of a target current ripple for an inductor current I_{L}).

FIG. 3C illustrates a block diagram of selected components of boost converter 20 depicting operation in a boost inactive mode, in accordance with embodiments of the present disclosure. Boost converter 20 may operate in the boost inactive mode when supply voltage V_{SUPPLY} generated by boost converter 20 rises above hysteresis voltage V_{HYST} and a sense voltage VDD_SENSE remains below supply voltage V_{SUPPLY}. In the boost inactive mode, control circuit 40 may deactivate (e.g., disable, open, turn off) bypass switch 30, charge switches 34, and rectification switches 36. Thus, when sense voltage VDD_SENSE remains below supply voltage V_{SUPPLY}, control circuit 40 prevents boost converter 20 from entering the bypass mode in order to not backpower battery 22 from supply voltage V_{SUPPLY}. Further, if supply voltage V_{SUPPLY} should fall below threshold minimum voltage V_{MIN}, control circuit 40 may cause boost converter 20 to again enter the boost active mode in order to maintain supply voltage V_{SUPPLY} between threshold minimum voltage V_{MIN} and hysteresis voltage V_{HYST}.

Accordingly, via operation in the above-described modes, boost converter 20 may operate to provide hysteretic control of supply voltage V_{SUPPLY} between threshold minimum voltage V_{MIN} and a hysteresis voltage V_{HYST}. It may be desirable to operate boost converter 20 in accordance with the following constraints:

1) When operating in the bypass mode and supply voltage V_{SUPPLY} drops below its setpoint threshold minimum voltage V_{MIN}, control circuit 40 causes low-latency transition from the bypass mode to the boost active mode, in order quickly pump current onto output capacitor 38.

2) When operating in the boost active mode, provide low-latency hysteretic control of supply voltage V_{SUPPLY} between threshold minimum voltage V_{MIN} and hysteresis voltage V_{HYST} in order to control a voltage ripple on supply voltage V_{SUPPLY} and prevent supply voltage V_{SUPPLY} from drooping below threshold minimum voltage V_{MIN}.

3) Load current I_{LOAD} may be a highly dynamic signal that may cause ripple on current I_{BAT}. Due to sense resistor 28 and other resistances, ripple on current I_{BAT} may lead to ripple on voltage VDD_SENSE that may cause control circuit 40 to rapidly toggle the control signal for closing bypass switch 30. It may be desirable to prevent unnecessary toggling of the control signal for closing bypass switch 30.

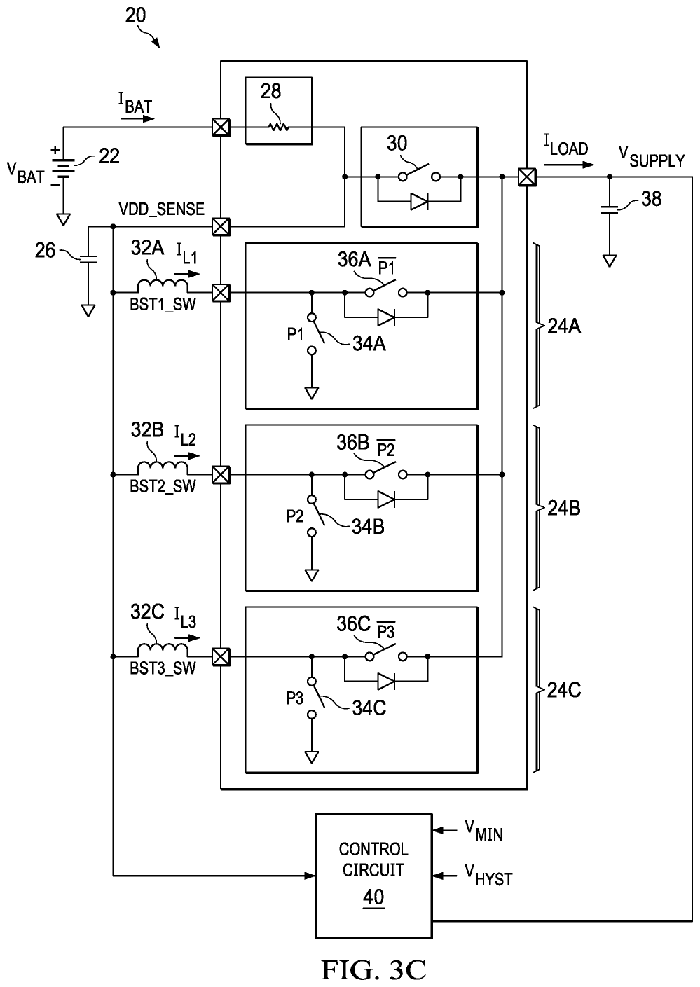

FIG. 4 illustrates a block diagram of selected components of an example control circuit 40A for a boost converter, in accordance with embodiments of the present disclosure. In some embodiments, control circuit 40A may be used to implement control circuit 40 shown in FIGS. 3A-3C. Control circuit 40A may comprise a plurality of comparators 42A, 42B, and 42C. Comparator 42A may be configured to compare voltage VDD_SENSE to supply voltage V_{SUPPLY} and generate comparison signal C₁ based on the comparison (e.g., C₁=1 if VDD_SENSE>V_{SUPPLY}; C₁=0 if VDD_SENSE<V_{SUPPLY}). Comparator 42B may be configured to compare hysteresis voltage V_{HYST} to supply voltage V_{SUPPLY} and generate comparison signal C₂ based on the comparison (e.g., C₂=1 if V_{HYST}<V_{SUPPLY}; C₂=0 if V_{HYST}>V_{SUPPLY}). Comparator 42C may be configured to compare threshold minimum voltage V_{MIN} to supply voltage V_{SUPPLY} and generate comparison signal C₃ based on the comparison (e.g., C₃=1 if V_{MIN}>V_{SUPPLY}; C₃=0 if V_{MIN}<V_{SUPPLY}).

As also shown in FIG. 4, control circuit 40A may include a digital portion 44 and an analog portion 46. Digital portion 44 may include a zero-order hold circuit 48 and a timer circuit 50. Zero-order hold circuit 48 may comprise any suitable system, device, or apparatus configured to sample comparison signal C₁ at its input and hold the value of comparison signal C₁ at its output for a sampling period after input sampling. As described in greater detail below, timer circuit 50 may implement a state machine for generating, at its output, a control signal BYPASS_ALLOW for allowing activation of bypass switch 30. As a result, timer circuit 50 may provide for time-based hysteresis to prevent unnecessary toggling of bypass switch 30.

Analog portion 46 may include a set-reset latch 52, a logical inverter 54, a logical OR gate 56, a logical inverter 58, a logical AND gate 60, and a set-reset latch 62. Set-reset latch 52 may receive comparison signal C₃ at its set input and comparison signal C₂ at its reset input and generate therefrom a control signal BOOST_ACTIVE for controlling the boost active mode of boost converter 20 (e.g., assertion of control signal BOOST_ACTIVE indicates that boost converter 20 is to operate in the boost active mode).

Logical OR 56 gate may perform a logical OR operation on control signal BOOST_ACTIVE and the complement of control signal BYPASS_ALLOW as inverted by logical inverter 54 in order to generate a control signal BOOST_OPEN_REQ. Logical AND gate 60 may perform a logical AND operation on comparison signal C₁ and the complement of control signal BOOST_OPEN_REQ as inverted by logical inverter 58 in order to generate a signal received at the set input of set-reset latch 62. Set-reset latch 62 may also receive control signal BOOST_OPEN_REQ at its reset input and generate therefrom a control signal BYPASS_CLOSED for controlling bypass switch 30 of boost converter 20 (e.g., bypass switch 30 activated when control signal BYPASS_CLOSED is asserted and bypass switch 30 deactivated when control signal BYPASS_CLOSED is deasserted).

The architecture of control circuit 40A may satisfy the constraints identified above. First, in the event that V_{SUPPLY}<V_{MIN}, analog portion 46 may provide a low-latency path (e.g., comparison signal C₃) for entering the boost active mode (e.g., assertion of control signal BOOST_ACTIVE) and deactivating bypass switch 30 (e.g., deassertion of control signal BYPASS_CLOSED). Further, set-reset latch 52 may maintain a low-latency hysteretic behavior of V_{SUPPLY} (e.g., toggling of control signal BOOST_ACTIVE in response to comparison signals C₂ and C₃).

Further, bypass switch 30 may be closed as follows:

(a) If VDD_SENSE>V_{SUPPLY} (e.g., C₁=1) for a programmable length of time, timer 50 may allow control signal BYPASS_ALLOW to be asserted;

(b) if V_{SUPPLY}>V_{HYST}>V_{MIN} (e.g., C₂=1, C₃=0), control signal BOOST_ACTIVE may be deasserted; and

(c) conditions (a) and (b) above may cause control signal BOOST_OPEN_REQ to be deasserted which may set set-reset latch 62 and cause set-reset latch 62 to assert control signal BYPASS_CLOSED to activate bypass switch 30. Thus, the architecture of control circuit 40A provides both time hysteresis (condition (a) above) and level-hysteresis (condition (b) above) to minimize or eliminate unnecessary toggling of bypass switch 30.

It is noted that if VDD_SENSE<V_{SUPPLY} (e.g., C₁=0), time 50 may reset causing control signal BYPASS_ALLOW to be deasserted and prevent bypass switch 30 from being activated. However, because timer 50 is implemented digitally, processing delays may exist. Thus, it may be possible that control signal BYPASS_ALLOW is asserted after C₁=0 for short periods of time. To avoid such a hazard, logical AND gate 60 may serve to pre-mask the set input of set-reset latch 62 using fast analog logic of logical AND gate 60.

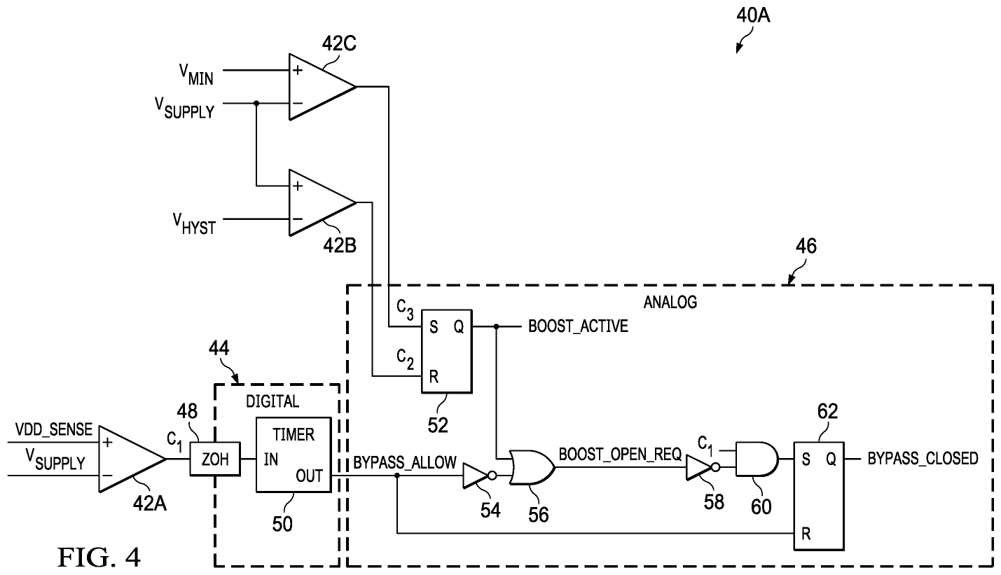

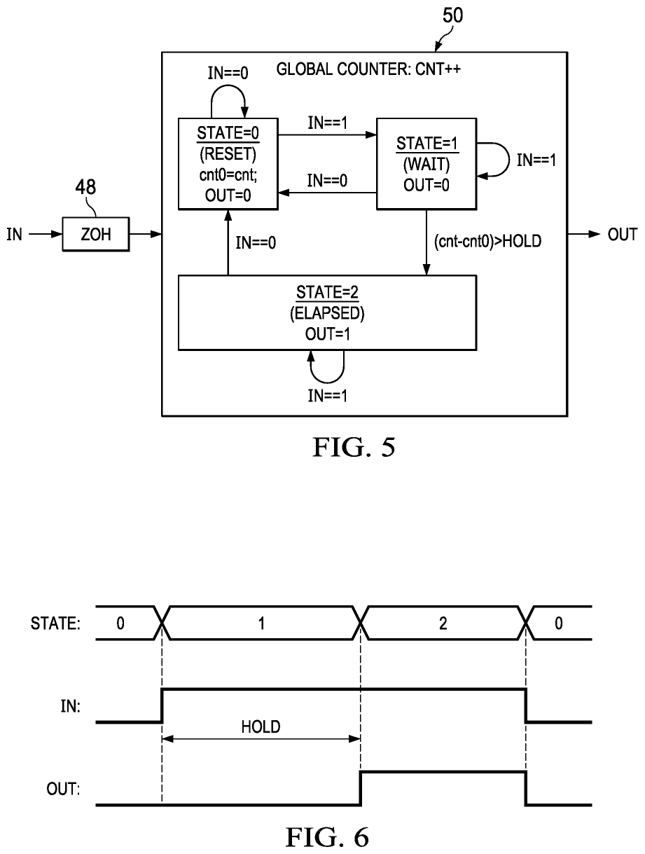

FIG. 5 illustrates a block diagram of a state machine that may be implemented by timer 50, in accordance with embodiments of the present disclosure. FIG. 6 illustrates an example timing diagram associated with the state machine implemented by timer 50, in accordance with embodiments of the present disclosure. As shown in FIG. 5, timer 50 may have a Reset State (State=0) in which an initialization value CNT0 may be set to the value of a global counter CNT implemented by timer 50 and the output of timer 50 (e.g., control signal BYPASS_ALLOW) may be deasserted. Timer 50 may remain in the Reset State until the input to timer 50 (e.g., comparison signal C₁, as held by zero order hold 48) is asserted at which point timer 50 may proceed to a Wait State (State=1).

In the Wait State, timer 50 may maintain its output as deasserted. From the Wait State, timer 50 may proceed again to the Reset State if the input to timer 50 is deasserted. Otherwise, timer 50 may remain in the Wait State as long as the input to timer 50 is asserted, with the exception that timer 50 may proceed to an Elapsed State (State=2) if global counter CNT exceeds initialization value CNT0 by a threshold HOLD.

In the Elapsed State, timer 50 may assert its output. Timer 50 may remain in the Elapsed State until the input to timer 50 is deasserted.

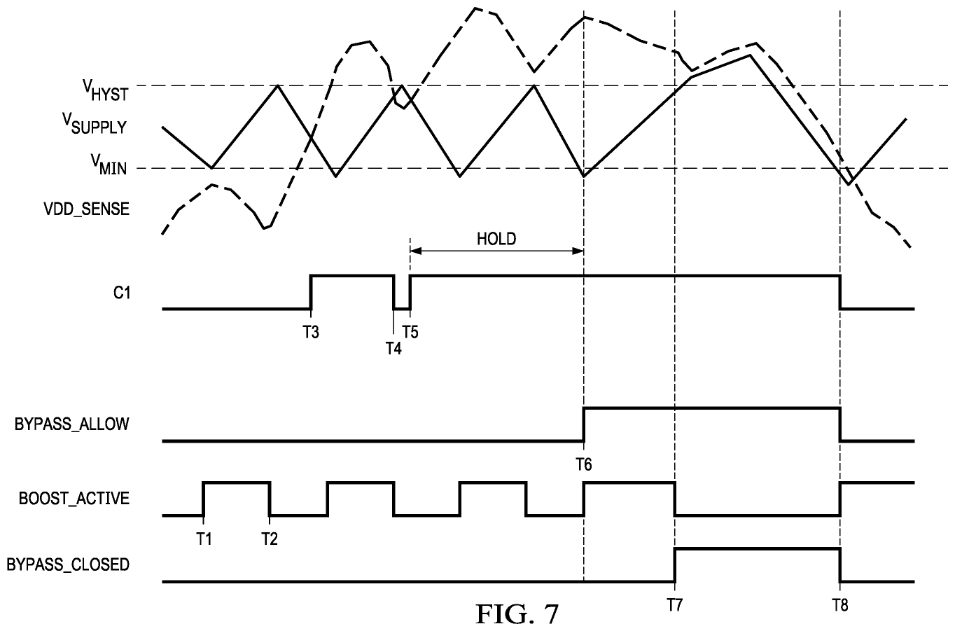

FIG. 7 illustrates an example timing diagram of various signals associated with control circuit 40A, in accordance with embodiments of the present disclosure. At the start of timing diagram of FIG. 7, control signal BYPASS_CLOSED may be deasserted and control signal BOOST_ACTIVE may toggle between asserted and deasserted. At time T1, V_{SUPPLY}<V_{MIN}, and control circuit 40A may assert control signal BOOST_ACTIVE. At time T2, V_{SUPPLY}>V_{HYST}, and control circuit 40A may deassert control signal BOOST_ACTIVE. At time T3, VDD_SENSE>V_{SUPPLY} and control circuit 40A may cause timer 50 to begin counting. At time T4, before timer 50 expires, VDD_SENSE<V_{SUPPLY} and thus timer 50 is reset. At time T5, VDD_SENSE>V_{SUPPLY} and control circuit 40A may cause timer 50 to again begin counting. Notably, between times T3 and T5, bypass switch 30 remains open, illustrating that time hysteresis, implemented by timer 50, may prevent unnecessary toggling of bypass switch 30.

At time T6, timer 50 may expire (e.g., CNT−CNT0>HOLD), and thus control circuit 40A may assert control signal BYPASS_ALLOW. At this point, control circuit 40A is waiting for control signal BOOST_ACTIVE before asserting control signal BOOST_OPEN_REQ. At time T7, control circuit 40A may assert control signal BYPASS_CLOSED to activate bypass switch 30 in response to control signal BOOST_ACTIVE being deasserted and comparison signal C₁ is asserted (VDD_SENSE>V_{SUPPLY}). A short time after time T7, a load may be applied to an output of power converter that causes supply voltage V_{SUPPLY} and voltage VDD_SENSE to drop. At time T8, V_{SUPPLY}<V_{MIN}, causing comparison signal C₃ to be deasserted, and thus control circuit 40A may assert control signal BOOST_ACTIVE, and in turn set-reset latch 62 may reset and control circuit 40A may deassert control signal BYPASS_CLOSED.

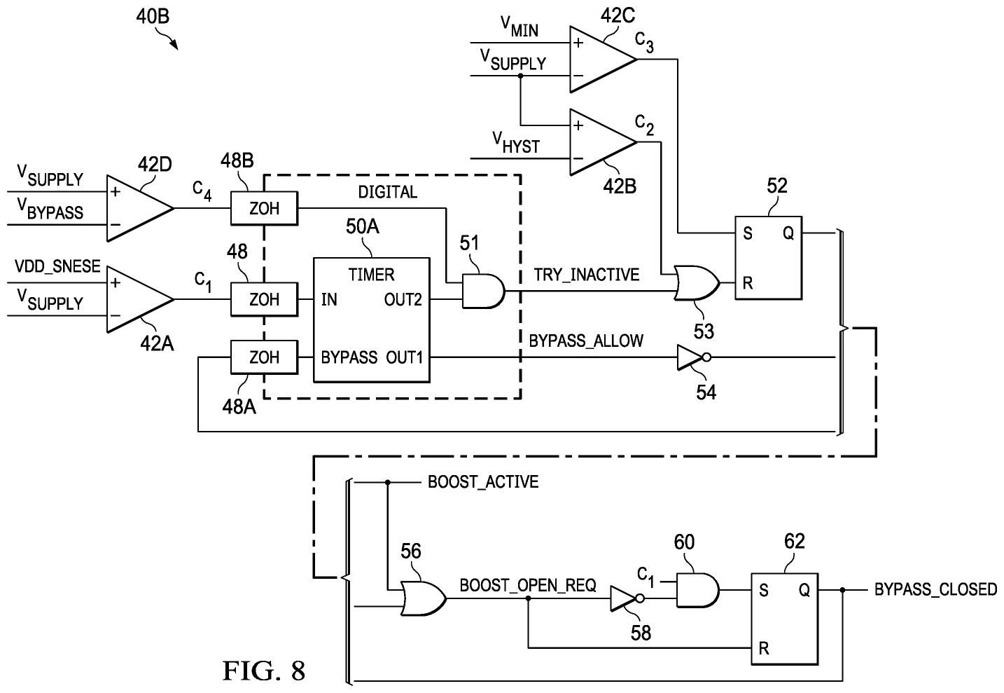

FIG. 8 illustrates a block diagram of selected components of an example control circuit 40B for a boost converter, in accordance with embodiments of the present disclosure. In some embodiments, control circuit 40B may be used to implement control circuit 40 shown in FIGS. 3A-3C. Control circuit 40B may be similar in many respects to control circuit 40A, and thus, only the differences between control circuit 40A and control circuit 40B may be discussed below.

One difference between control circuit 40A and control circuit 40B is that control circuit 40B may include a comparator 42D configured to compare supply voltage V_{SUPPLY} to a bypass threshold voltage V_{BYPASS}, wherein V_{MIN}<V_{BYPASS}<V_{HYST}, and generate comparison signal C₄ based on the comparison (e.g., C₄=1 if V_{SUPPLY}>V_{BYPASS}; C₄=0 if V_{SUPPLY}<V_{BYPASS}). The addition of comparator 42D may be motivated by the fact that in control circuit 40A, after timer 50 expires, control circuit 40A would need to wait for V_{SUPPLY}>V_{HYST} before disabling boost converter 20 and activating bypass switch 30. In some cases, it might be possible to disable boost converter 20 and activate bypass switch 30 much sooner. In such cases, the added delay could result in voltage VDD_SENSE exceeding supply voltage V_{SUPPLY} by the time bypass switch 30 is activated, especially if battery voltage V_{BAT} increases rapidly.

As shown in FIG. 8, control circuit 40B may include zero-order hold 48A, zero-order hold 48B, logical AND gate 51, and logical OR gate 53. Further, control circuit 40B may include a timer 50A in lieu of timer 50. In circuit 40B, the condition for assertion of control signal BYPASS_CLOSED is that VDD_SENSE>V_{SUPPLY} (e.g., C₁=1) for a programmable length of time and V_{SUPPLY}>V_{BYPASS} (e.g., C₄=1). Further, when timer 50A expires and comparison signal C₄ is asserted, control circuit 40B may assert a control signal TRY_INACTIVE, resetting set-reset latch 52 and deasserting control signal BOOST_ACTIVE, disabling boost converter 20. Because control signal BYPASS_ALLOW is asserted and comparison signal C₁ is asserted, control circuit 40B may deassert control signal BOOST_OPEN_REQ, setting set-reset latch 62 and causing control signal BYPASS_CLOSED to be asserted. Once control signal BYPASS_CLOSED is asserted, timer 50A may deassert its output OUT2 which may deassert control signal TRY_INACTIVE via logical AND gate 51. As a result, timer 50A may include a BYPASS input and a new internal state to independently control its outputs OUT1 (e.g., control signal BYPASS_ALLOW) and OUT2.

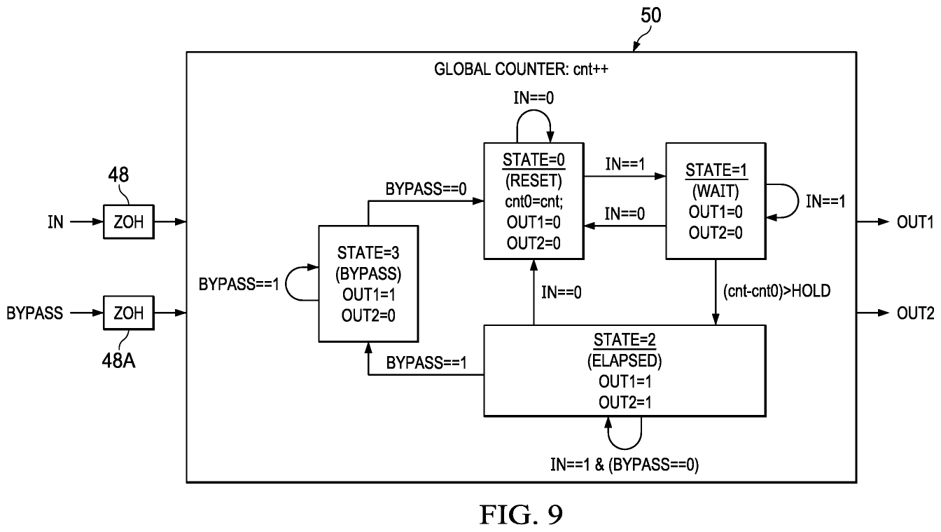

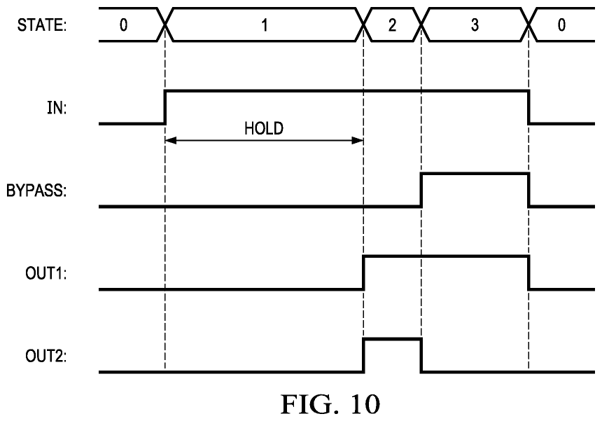

FIG. 9 illustrates a block diagram of a state machine that may be implemented by timer 50A, in accordance with embodiments of the present disclosure. FIG. 10 illustrates an example timing diagram associated with the state machine implemented by timer 50A, in accordance with embodiments of the present disclosure. As shown in FIG. 9, timer 50A may have a Reset State (State=0) in which an initialization value CNT0 may be set to the value of a global counter CNT implemented by timer 50A and output OUT1 and output OUT2 of timer 50A (e.g., control signal BYPASS_ALLOW) may be deasserted. Timer 50A may remain in the Reset State until the input to timer 50A (e.g., comparison signal C₁, as held by zero-order hold 48) is asserted at which point timer 50A may proceed to a Wait State (State=1).

In the Wait State, timer 50A may maintain its outputs OUT1 and OUT 2 as deasserted. From the Wait State, timer 50A may proceed again to the Reset State if the input to timer 50A is deasserted. Otherwise, timer 50A may remain in the Wait State as long as the input to timer 50A is asserted, with the exception that timer 50A may proceed to an Elapsed State (State=2) if global counter CNT exceeds initialization value CNT0 by a threshold HOLD.

In the Elapsed State, timer 50A may assert its outputs OUT1 and OUT2. Timer 50A may remain in the Elapsed State while its input remains asserted and bypass input remains deasserted. If the input to timer 50A is deasserted, timer 50A may proceed again to the Reset State. If the bypass input to timer 50A is asserted, timer 50A may proceed to a Bypass State (State 3).

In the Bypass State, timer 50A may deassert its output OUT2 and leave its output OUT1 asserted. Timer 50A may remain in the Bypass State while its bypass input remains asserted. Once its bypass input becomes deasserted, timer 50A may proceed again to the Reset State.

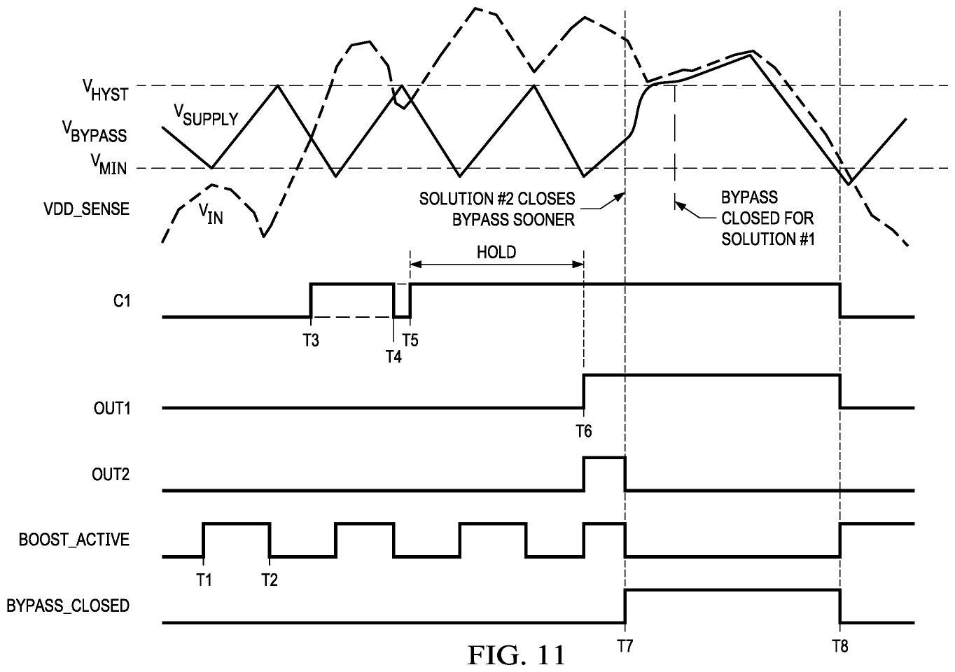

FIG. 11 illustrates an example timing diagram of various signals associated with control circuit 40B, in accordance with embodiments of the present disclosure. At the start of the timing diagram of FIG. 11, control signal BYPASS_CLOSED may be deasserted and control signal BOOST_ACTIVE may toggle between asserted and deasserted. At time T1, V_{SUPPLY}<V_{MIN}, and control circuit 40B may assert control signal BOOST_ACTIVE. At time T2, V_{SUPPLY}>V_{MIN}, and control circuit 40B may deassert control signal BOOST_ACTIVE. At time T3, VDD_SENSE>V_{SUPPLY} and control circuit 40A may cause timer 50A to begin counting. At time T4, before timer 50A expires, VDD_SENSE<V_{SUPPLY} and thus timer 50A is reset. At time T5, VDD_SENSE>V_{SUPPLY} and control circuit 40A may cause timer 50A to again begin counting.

At time T6, timer 50A may expire (e.g., CNT−CNT0>HOLD), and thus control circuit 40B may assert control signal BYPASS_ALLOW and timer outputs OUT1 and OUT2. At this point, control circuit 40B may be waiting for control signal BOOST_ACTIVE to be asserted before asserting control signal BOOST_OPEN_REQ. At time T7, V_{SUPPLY}>V_{BYPASS}, which may cause control signal TRY_INACTIVE to be asserted which may reset set-reset latch 52 and cause deassertion of control signal BOOST_ACTIVE. Consequently, control circuit 40B may assert control signal BYPASS_CLOSED to activate bypass switch 30 in response to control signal BOOST_ACTIVE being deasserted and comparison signal C₁ is asserted (VDD_SENSE>V_{SUPPLY}). A short time after time T7, a load may be applied to an output of power converter that causes supply voltage V_{SUPPLY} and voltage VDD_SENSE to drop. At time T8, V_{SUPPLY}<V_{MIN}, causing comparison signal C₃ to be deasserted, and thus control circuit 40B may assert control signal BOOST_ACTIVE, and in turn set-reset latch 62 may reset and control circuit 40A may deassert control signal BYPASS_CLOSED.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A power conversion system, comprising:
a power converter configured to receive an input voltage and generate an output voltage;
a bypass switch arranged in parallel with the power converter and arranged to couple the input voltage to the output voltage when the bypass switch is activated; and
a control circuit configured to control the power converter and the bypass switch based on the output voltage.

2. The power conversion system of claim 1, wherein the control circuit is further configured to control the power converter and the bypass switch based on the input voltage and the output voltage.

3. The power conversion system of claim 2, wherein the control circuit is further configured to disable the power converter and activate the bypass switch if the output voltage is less than the input voltage for at least a predetermined period of time.

4. The power conversion system of claim 1, wherein the control circuit is further configured to disable the power converter and activate the bypass switch if the output voltage is greater than a defined hysteretic control voltage for regulating the output voltage.

5. The power conversion system of claim 1, wherein the control circuit is further configured to disable the power converter and activate the bypass switch if the output voltage is greater than a defined bypass control voltage and less than a hysteretic control voltage for regulating the output voltage.

6. The power conversion system of claim 1, wherein the control circuit is further configured to enable the power converter and deactivate the bypass switch if the output voltage is lesser than a minimum threshold voltage for regulating the output voltage.

7. The power conversion system of claim 1, wherein the control circuit comprises at least one latch to control operation of the power converter and the bypass switch.

8. The power conversion system of claim 7, wherein at least one latch is an analog latch.

9. A method in a power conversion system, comprising a power converter configured to receive an input voltage and generate an output voltage and a bypass switch arranged in parallel with the power converter and arranged to couple the input voltage to the output voltage when the bypass switch is activated, the method comprising:
controlling the power converter and the bypass switch based on the output voltage.

10. The method of claim 9, wherein the control circuit is further configured to control the power converter and the bypass switch based on the input voltage and the output voltage.

11. The method of claim 10, wherein the control circuit is further configured to disable the power converter and activate the bypass switch if the output voltage is less than the input voltage for at least a predetermined period of time.

12. The method of claim 9, wherein the control circuit is further configured to disable the power converter and activate the bypass switch if the output voltage is greater than a defined hysteretic control voltage for regulating the output voltage.

13. The method of claim 9, wherein the control circuit is further configured to disable the power converter and activate the bypass switch if the output voltage is greater than a defined bypass control voltage and less than a hysteretic control voltage for regulating the output voltage.

14. The method of claim 9, wherein the control circuit is further configured to enable the power converter and deactivate the bypass switch if the output voltage is lesser than a minimum threshold voltage for regulating the output voltage.

15. The method of claim 9, wherein the control circuit comprises at least one latch to control operation of the power converter and the bypass switch.

16. The method of claim 15, wherein at least one latch is an analog latch.
